(19) United States
(12) Patent Application Publication
(10) Pub. No.: US 2024/0234829 A1
(43) Pub. Date: Jul. 11, 2024

(54) ELECTROCHEMICAL ELEMENT FOR A BATTERY, AND CORRESPONDING BATTERY

(71) Applicant: SAFT, LEVALLOIS PERRET (FR)

(72) Inventors: Alexandre BEUGNON, LE PIAN MEDOC (FR); Valentin BLONZ, LE BOUSCAT (FR)

(73) Assignee: SAFT, LEVALLOIS PERRET (FR)

(21) Appl. No.: 18/562,098

(22) PCT Filed: May 16, 2022
(86) PCT No.: PCT/EP2022/063189

§ 371 Date: Nov. 17, 2023

(30) Foreign Application Priority Data
May 18, 2021 (FR) 21 05171

(51) Int. Cl. H01M 10/0585; H01M 10/0525; H01M 50/103; H01M 50/105; H01M 50/176; H01M 50/178; H01M 50/533; H01M 50/547; H01M 50/557; H01M 50/566

(52) U.S. Cl. CPC H01M 10/0585; H01M 10/0525; H01M 50/103; H01M 50/105; H01M 50/176; H01M 50/178; H01M 50/533; H01M 50/547; H01M 50/557; H01M 50/566

(57) ABSTRACT

The present electrochemical element for a battery comprises a first electrode of a first polarity, a first connection member for the first polarity, a second electrode of a second polarity, a second connection member for the second polarity, and a casing comprising a first wall and a second wall. The casing comprises a first edge and a second edge which form an enveloping geometric shape having a corner.

The first connection member and the second connection member are arranged completely within the enveloping geometric shape. The first connection member and the second connection member are arranged in a first corner of the enveloping geometric shape.

### CROSS REFERENCE TO RELATED APPLICATIONS

The present application is a U.S. National Phase Application under 35 U.S.C. § 371 of International Patent Application No. PCT/EP2022/063189 filed May 16, 2022, which claims priority of French Patent Application No. 21 05171 filed May 18, 2021. The entire contents of which are hereby incorporated by reference.

### FIELD OF THE INVENTION

The present invention relates to an electrochemical element for a battery, of the type comprising
a first electrode of a first polarity,
a first connection member of the first polarity,
a second electrode of a second polarity,
a second connection member of the second polarity,
a casing comprising a first wall and a second wall,
the casing comprising at least one first edge and at least one second edge,
the first and second edges form an enveloping geometric shape having at least one corner.

### BACKGROUND

Electrochemical elements and batteries are known e.g. from WO95/16283. The electrochemical element disclosed by the present document comprises connection tabs arranged in the corners of the electrochemical element.

The battery manufactured from the electrochemical elements comprises a plastic casing. The electrochemical element of the present document is used for manufacturing parallelepipedal batteries.

Other electrochemical assemblies or electrochemical batteries are known from CN108400385; WO2016/205663A1 (EP3311443); KR20160041402A; U.S. Ser. No. 10/490,781B2 (US20150364729A): CN202373667U; US2013101891A1; WO2012057854A1; WO2005039013A2 (EP1678804); WO03026042A1 (EP1428272); and WO9120100A1 (EP0487699).

The goal of the invention is to propose an electrochemical element which has a large electrical energy storage capacity for a given volume. Moreover, the electrochemical element should be easy and economical to manufacture and have a high operational safety.

### SUMMARY

To this end, the invention provides an electrochemical element for a battery, characterized in that the first connection member of the first polarity and the second connection member of the second polarity are arranged completely inside the enveloping geometric shape, in that
the first connection member of the first polarity is arranged in a first corner of the enveloping geometric shape and
the second connection member of the second polarity is also arranged in the first corner of the enveloping geometric shape.

According to particular embodiments of the electrochemical element for battery, same can have one or a plurality of the following features:
The enveloping geometric shape is an enveloping quadrilateral, in particular a rectangle or a trapezoid.
A connection member of the first polarity and a connection member of the second polarity are arranged only in one corner of the enveloping geometric shape, and in no other corner of the enveloping geometric shape, which may be present, is there a connection member of the second polarity the electrochemical element.
The first connection member of the first polarity and the second connection member of the second polarity are arranged side by side or the first connection member of the first polarity and the second connection member of the second polarity are juxtaposed.
The first connection member of the first polarity includes a terminal portion and/or wherein the second connection member of the second polarity includes a terminal portion, wherein each terminal portion is suitable for being electrically connected to an associated terminal and wherein each terminal portion has a substantially triangular shape.
The electrochemical element includes a linking element of plastic material which holds together the first connection member of the first polarity and the second connection member of the second polarity in a predetermined configuration and electrically isolates the first connection member of the first polarity from the second connection member of the second polarity.
The linking element is overmolded around the first connection member of the first polarity and the second connection member of the second polarity.
The first connection member of the first polarity and/or the second connection member of the second polarity is/are attached to the respective electrodes thereof, in particular by ultrasonic welding.
The first wall and the second wall each comprise a metal base sheet and wherein the metal base sheets each have a thickness comprised between 20 μm and 150 μm, in particular either between 30 μm and 60 μm or between 60 μm and 100 μm or between 60 μm and 90 μm.

A further subject matter of the invention relates to a battery comprising a casing and at least one electrochemical element, the battery preferentially comprising a first terminal and a second terminal, characterized in that the at least one electrochemical element (10) is an element as defined above, preferentially, the first connection member of the first polarity is electrically connected to the first terminal and the second connection member of the second polarity is electrically connected to the second terminal.

### BRIEF DESCRIPTION OF THE DRAWINGS

The invention will be better understood upon reading the following description, given only as an example and making reference to the enclosed drawings, wherein:

FIG. 1 is a schematic front view of a battery comprising an electrochemical element according to a first embodiment of the invention;

FIG. 2 is a front view of the electrochemical element shown in FIG. 1, a wall of the casing being omitted;

FIG. 3 is a perspective sectional view of the electrochemical element shown FIG. 1;

FIG. 4 is a magnified view of a detail of the electrochemical element shown in FIG. 1;

FIG. 5 is a magnified view of a detail shown in FIG. 2;

FIG. 6 is a perspective view of a connection assembly of an electrochemical element shown in FIGS. 1 to 5, the connection assembly being according to a first embodiment;

FIG. 7 is a plan view of the connection assembly shown in FIG. 6,

FIG. 8 is a front view of the connection assembly shown in FIG. 6;

FIG. 9 is a perspective view of a connection assembly according to a second embodiment, the view being identical to the view shown in FIG. 6;

FIG. 10 is a plan view of the connection assembly shown in FIG. 9,

FIG. 11 is a front view of the connection assembly shown in FIG. 9;

FIG. 12 is a lateral view of the connection assembly shown in FIG. 9; and

FIG. 13 is a perspective view of a connection assembly according to a third embodiment, the view being identical to the view shown in FIG. 6.

### DETAILED DESCRIPTION

The following description contains technical features of the invention. Such technical features, although presented in a technical context and, if appropriate, in combination with other technical features, can be used every time individually, without the other technical features, insofar as technically possible.

In the description of the different embodiments, the analogous members bear the same references. Also, unless otherwise indicated, each feature described with reference to an embodiment of the invention or to a variant of an embodiment is applicable alone or in any technically possible combination to the other embodiments or variants.

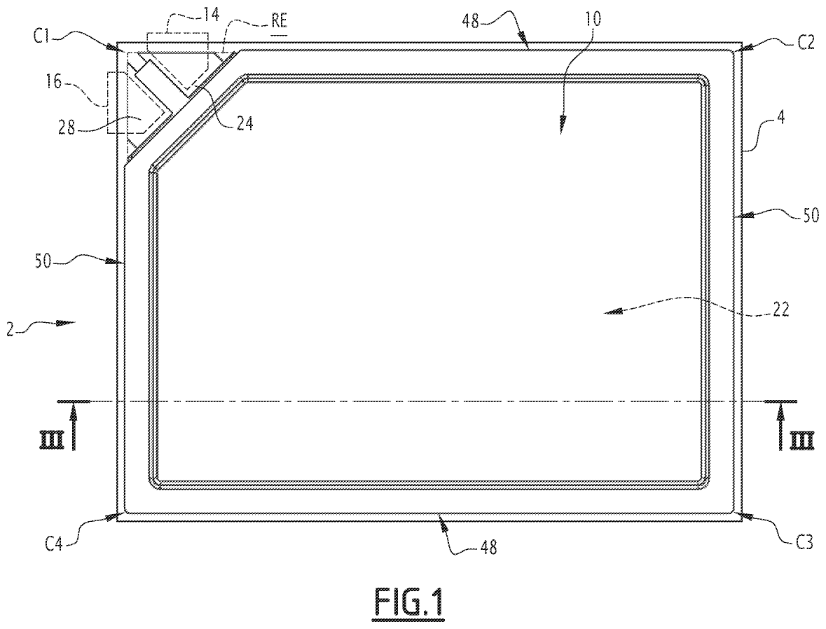

FIG. 1 shows a battery according to a first embodiment of the invention, denoted by the general reference 2. The battery 2 is an electrochemical battery such as currently used in electric vehicles. However, other areas of application of the battery 2 are conceivable, such as energy storage, electric mobility, aviation, railways.

The battery 2 comprises a housing 4 or a container and an electrochemical element 10. In practice, the battery 2 comprises a plurality of electrochemical elements 10 connected in series or in parallel in order to obtain the desired electrical voltage and/or capacity. The electrochemical element 10 is arranged in the housing 4.

The housing 4 is e.g. parallelepipedal, in particular rectangular, and comprises housing walls, a first terminal 14 and a second terminal 16. The housing walls are more rigid than the walls of the electrochemical element 10 (see hereinafter).

The battery 2 could comprise a cooling device which is not shown.

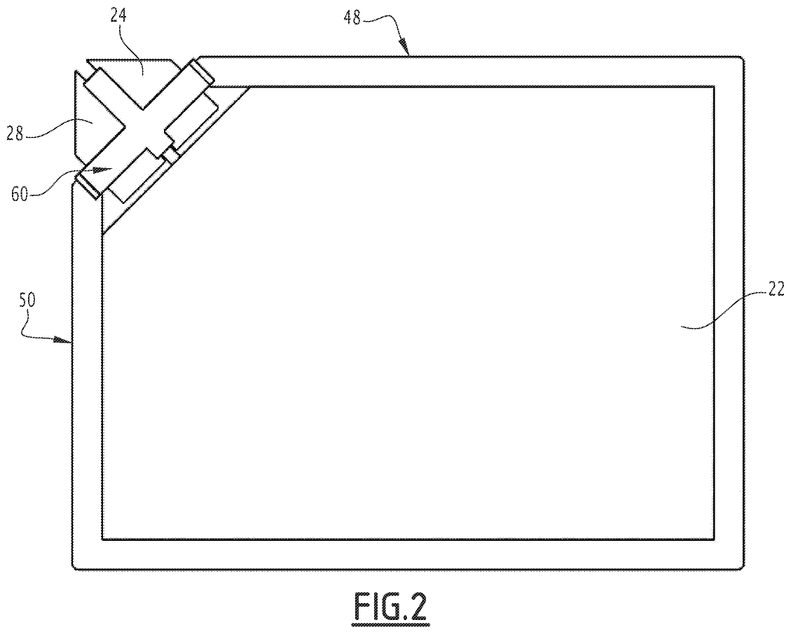

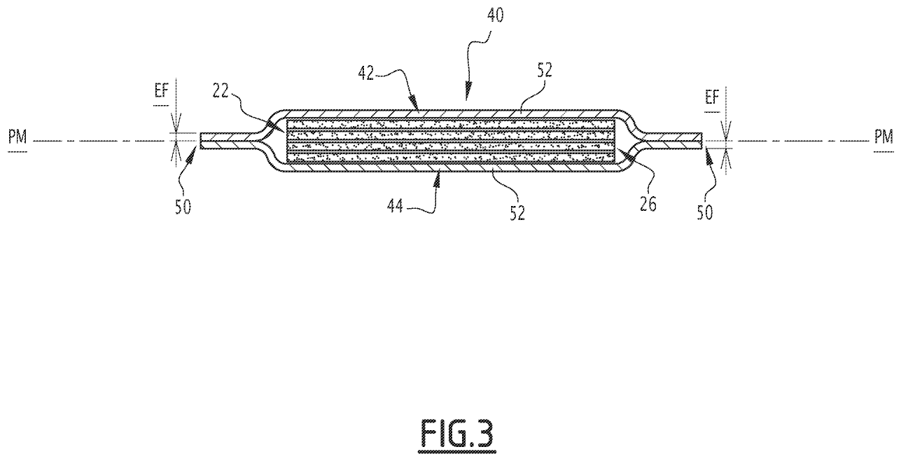

The electrochemical element 10 or each electrochemical element 10 extends along a median plane PM (see FIG. 3) which is parallel to the plane of FIGS. 1 and 2 and perpendicular to the plane of FIG. 3.

The electrochemical element 10 or each electrochemical element 10 comprises a first electrode of a first polarity 22, a first connection member of the first polarity 24, a second electrode of a second polarity 26, and a second connection member of the second polarity 28.

The electrochemical element 10 is e.g. of the Lithium-Ion type electrochemical element. The first electrode of the first polarity 22 comprises at least one current collector consisting of a metal strip, e.g. of aluminum, coated on at least one face of a mixture containing the active material. For example, in the case of a lithium secondary battery, the first electrode of the first polarity contains an active material which may be a metal oxide comprising lithium atoms, such as cobalt and lithium dioxide LCO (LiCoO₂), NMC (LiNixMnyCo_{1-x-y}O₂), NCA (LiNixCoyAl_{1-x-y}O₂), compounds such as LiMPO₄ type where M is selected from the group consisting of Fe, Co, Ni, Mn and a mixture thereof (e.g. LiFePO₄), LMO (LiMn₂O₄), compounds such as LiₓFe_{1-y}M_{y}PO₄ where M is selected from the group consisting of B, Mg, Al, Si, Ca, Ti, V, Cr, Mn, Co, Ni, Cu, Zn, Y, ZR, Nb and Mo and 0.8≤x≤1.2; 0≤y≤0.6 (e.g. LiMnFePO₄), compounds such as LiVPO₄F or analogous lithium compounds. The first electrode of the first polarity 22 is e.g. the positive electrode.

The second electrode of the second polarity 26 comprises at least one current collector formed of a metal strip, e.g. of copper, coated over at least one face with a mixture containing the active material. For example, in the case of a lithium secondary battery, the second electrode contains an active material which could be a carbonaceous material apt to insert lithium atoms, such as graphite or silicon, a lithiated titanium oxide LTO (e.g. with the formula Li₄Ti₅O₁₂) or an oxide of titanium and niobium TNO (e.g. with the formula TiNb₂O₇). The second electrode of the second polarity 26 is e.g. the negative electrode.

The electrochemical element 10 comprises a separator which separates the first electrode 22 from the second electrode 26. In the case of a Lithium-Ion electrochemical cell, the separator is permeable to lithium ions, but electrically insulating. The separator is e.g. a polyolefin membrane.

The first electrode of the first polarity 22 and the second electrode of the second polarity 26 extend generally parallel to the median plane PM.

The electrochemical element 10 further comprises an electrolyte, which can be liquid, such as an organic electrolyte containing lithium salts such as LiPF₆, either solid or gel, such as polyvinylidene fluoride (PVDF) polymers or a polyvinylidene fluoride-hexafluoropropylene copolymer (PVDF-HFP).

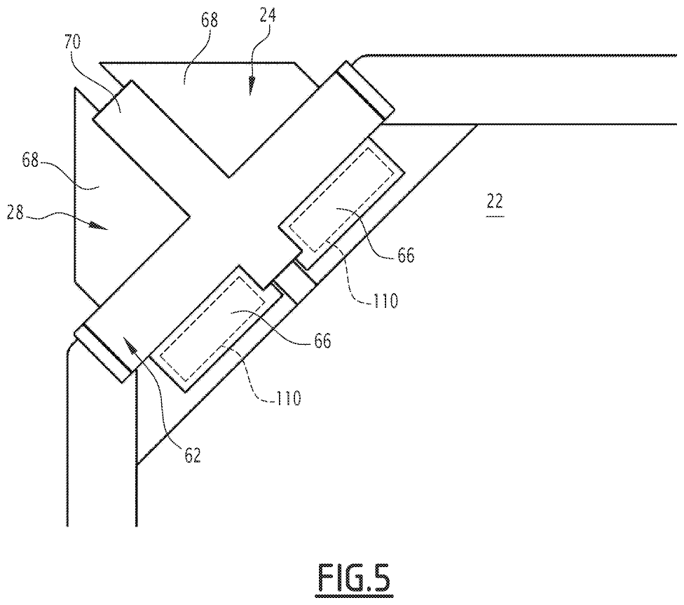

The first connection member of the first polarity 24 is electrically connected to the first terminal 14 and the second connection member of the second polarity 28 is electrically connected to the second terminal 16. The connection members are suitable for collecting the current from the associated electrode. The or each first connection member of the first polarity 24 is attached by welding or brazing to the associated current collector or to the associated electrode. Similarly, the or each second connection member of the second polarity 28 is attached by welding or brazing to the associated current collector or to the associated electrode. More particularly, the or each first connection member of the first polarity 24 is attached by ultrasonic welding to the associated current collector or to the associated electrode. Similarly, more particularly the or each second connection member of the second polarity 28 is attached by ultrasonic welding to the associated current collector or to the associated electrode. In FIG. 5, the above is illustrated by the ultrasonic welding zones 110. Ultrasonic welding is particularly advantageous because same makes it possible to connect thin sheets.

In the present embodiment, the electrochemical element 10 comprises exactly one first connection member of the first polarity 24 and one second connection member of the second polarity 28. In other words, the connection members of the electrochemical element consist of only one first connection member of the first polarity and only one second connection member of the second polarity.

The electrochemical element 10 or each electrochemical element 10 comprises a casing 40 provided with a first wall 42 and a second wall 44. The envelope 40 is of the “pouch” type, i.e. comprises relatively flexible and easily deformable walls. The walls of the casing 40 are thus more easily deformable and less rigid than the walls of the casing 4.

FIG. 3 shows the electrochemical element 10 in section along line III-III of FIG. 1. The housing 4 is omitted in FIG. 3.

The first wall 42 and the second wall 44 each comprise a sheet of metal, in particular of aluminum, each of which has a thickness EF comprised between 20 μm and 150 μm, in particular between 30 μm and 60 μm. Alternatively, the thickness EF can advantageously be between 60 μm and 100 μm or between 60 μm and 90 μm. The first wall 42 and the second wall 44 could further comprise a coating, e.g. of thermoplastic material, laid over the metal sheet. For example, the walls of the envelope are made of a multilayer film comprising, from the outside to the inside, an electrically insulating and mechanically protective layer, an aluminum foil and a layer of polypropylene (PP) and/or PPa—acid modified polypropylen. Preferentially, the walls of the casing consist of a multilayer film comprising, from the outside to the inside, a layer of polyethylene terephthalate (PET), a layer of nylon, an aluminum foil and a layer of polypropylene (PP) and/or PPa—acid modified polypropylen.

As can be seen in FIG. 1, the envelope 40 comprises two first edges 48, in the present case substantially parallel to one another, and two second edges 50, in the present case substantially parallel to one another, and in the present case substantially perpendicular to the first edges. Each of the first edges 48 is a long edge and each of the second edges 50 is a short edge. The term “short” means that the edge is shorter than each of the long edges and the term “long” means that the edge is longer than each of the short edges. The first edges 48 are e.g. edges opposite to each other and the second edges 50 are e.g. also edges opposite to each other. The first and/or second edges 48 and 50 can be substantially rectilinear.

In a variant, the first and/or the second edges 48 and 50 are not parallel and form e.g. a trapezoid. In a variant, the first and/or the second edges 48 and 50 do not have different lengths, same have identical lengths and therefore form e.g. a square or a diamond shape. In a variant, the casing 40 comprises at least a first edge and a second edge which are not parallel, preferentially substantially perpendicular to each other, and which together form a corner.

The first and the second edges 48 and 50 form in general, in a front view, an enveloping quadrilateral RE, in the present case an enveloping rectangle (FIG. 1), which is defined by the first and the second edges 48 and 50 and by the extension of said edges. The edges 48 and 50 coincide with the enveloping quadrilateral. The enveloping quadrilateral RE comprises four corners C1, C2, C3 and C4. In the Figures, the four corners C1 to C4 are arranged clockwise. Depending on the length of the first and the second edges 48 and 50 and the arrangement thereof, the enveloping quadrilateral RE could also be any quadrilateral, a square, a rhombus or a trapezoid. In another variant, the enveloping quadrilateral RE is replaced by an enveloping geometric shape having at least one corner, e.g. a semicircular shape.

The first connection member of the first polarity 24 is arranged in a first corner of the enveloping quadrilateral RE, in the present case C1, and the second connection member of the second polarity 28 is also arranged in the first corner of the enveloping quadrilateral, in the present case C1. The first connection member of the first polarity 24 and the second connection member of the second polarity 28 are thus arranged in the same corner of the enveloping quadrilateral RE. The first connection member of the first polarity 24 and the second connection member of the second polarity 28 are thus located closer to the corner C1 than to other corners C2 to C4.

In the present case, a connection member of the first polarity and is arranged a connection member of the second polarity are arranged only in one corner of the enveloping geometric shape or of the enveloping quadrilateral. In no other existing corner of the enveloping geometric shape or of the enveloping quadrilateral RE is a connection member of the electrochemical cell arranged.

According to the embodiment shown in FIGS. 1 to 8, the metal sheet of the first wall 42 and the metal sheet of the second wall 44 are two individual and separate metal base sheets 52, each of which has four edges. Each of the first edges 48 and of the second edges 50 is formed by two edges or edge zones of the two superposed base sheets attached to each other, e.g. by laser welding or by heat welding. The above is shown in FIG. 3. The casing 40 thus comprises four sides formed by an attachment line, in particular a welding line.

According to the invention, seen from the front, the first connection member of the first polarity 24 is arranged completely inside the enveloping quadrilateral RE. Moreover, seen from the front, the second connection member of the second polarity 28 is arranged completely inside the enveloping quadrilateral RE. In other words, the first and second terminals 24, 28 are arranged completely inside a cylinder having a section of the enveloping quadrilateral RE.

Each first connection member of the first polarity 24 and/or each second connection member of the second polarity 28 has edges which, in front view, are set back with respect to same, i.e. extend completely inside the enveloping quadrilateral RE. The above is advantageous because, during the installation into a module, an undesirable contact between the connection members and the casing is prevented. In a variant, the edges coincide with the enveloping quadrilateral RE.

FIG. 2 shows the electrochemical element 10 of FIG. 1, also seen from the front, but the first wall 42 of the casing 40 is omitted.

The connection member of the first polarity 24 consists of a connection member tab which is attached to a superposition of electrode sheets. Similarly, each second connection member of the second polarity 28 consists of a connection member tab which is attached to a superposition of electrode sheets.

Each of the connection member tabs comprises a metal sheet and, if appropriate, a coating. The connection member tab of the first connection member of the first polarity 24 is e.g. made of aluminum. The connection member tab of the second connection member of the second polarity 28 is e.g. made of copper and, if appropriate, coated with nickel.

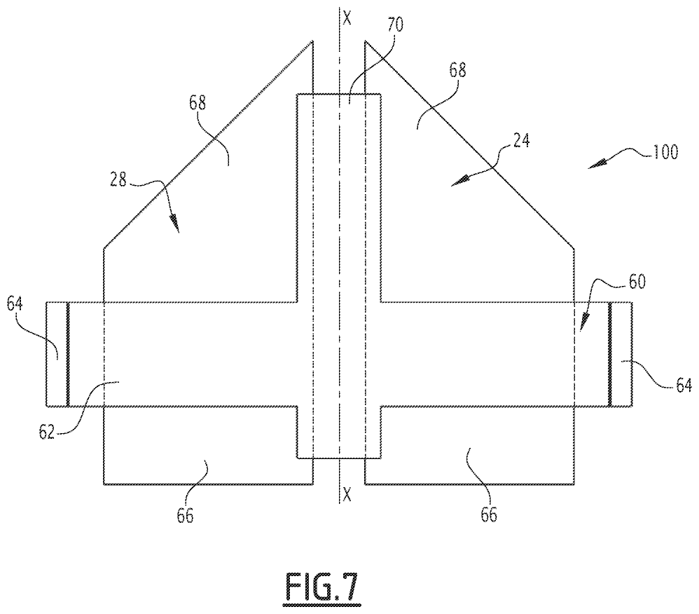

Each of the connection member tabs has a trapezoidal shape (see FIG. 7). Each trapezoid comprises two parallel trapezoid bases. Each trapezoid has a first trapezoid lateral edge, which is substantially perpendicular to the trapezoid bases. Each trapezoid has a second trapezoid lateral edge which is oblique with respect to the trapezoid bases.

The second lateral edge of the trapezoid is parallel to or can coincide with the associated edge 48 or 50 of the housing 40. The two second trapezoid lateral edges of the two adjacent tabs of the connection member form an angle therebetween e.g. 90°.

The two trapezoid bases of the two connection member tabs are parallel to each other.

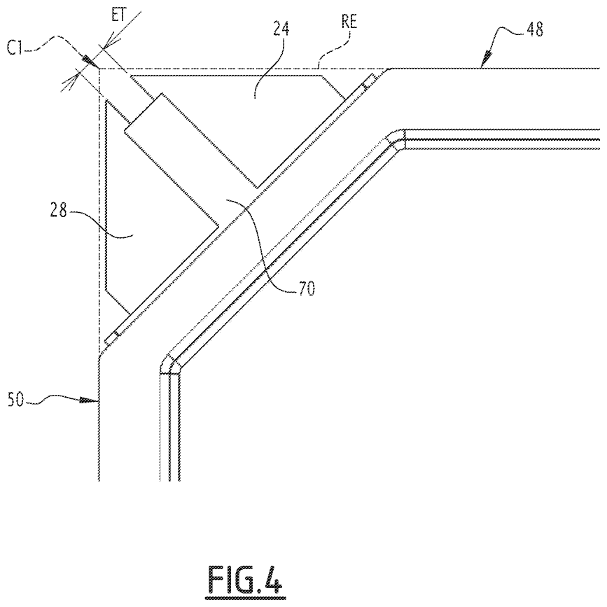

The connection member of the first polarity 24 and the connection member of the second polarity 28 are arranged side by side. In addition, the connection member of the first polarity 24 and the connection member of the second polarity 28 are arranged coplanar with each other in the median plane PM or in a plane parallel to the median plane PM. Also, the first connection member of the first polarity 24 and the second connection member of the second polarity 28 are arranged at a distance from each other along the median plane PM, without overlapping. In FIG. 4, the spacing of the connection members is referenced by ET.

The electrochemical element 10 comprises a connection member 60 which holds together the connection member of the first polarity 24 and the connection member of the second polarity 28 in a predetermined configuration, and which electrically isolates the first connection member of the first polarity 24 from the second connection member of the second polarity 28.

To this end, the linking element 60 is made of plastic, in particular thermoplastic, such as polypropylene or polyethylene. Preferentially, the linking element 60 is molded around the first connection member of the first polarity 24 and of the second connection member of the second polarity 28.

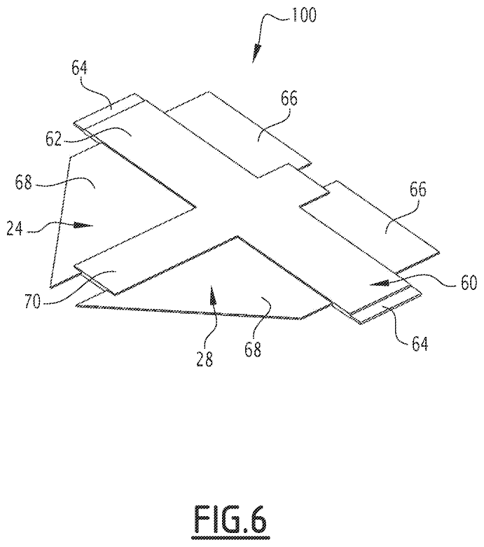

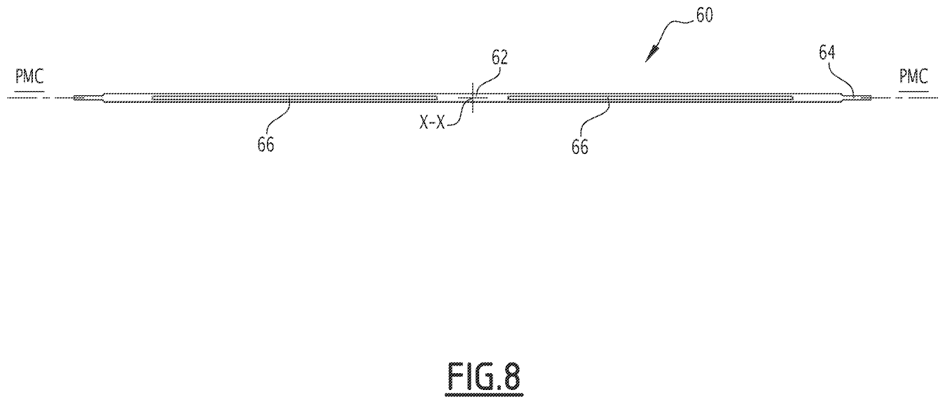

The linking element 60, the first connection member of the first polarity 24 and the second connection member of the second polarity 28 together form a connection assembly 100 which can be handled as one unit. The connection assembly 100 of the electrochemical cell of FIGS. 1 to 5 is shown in FIGS. 6 to 8. The connection assembly 100 is an assembly according to a first embodiment. The connection assembly 100 defines a plane PMC (FIG. 8), which, in the assembled state of the electrochemical element coincides with the median plane PM. The connection assembly 100 also defines a central axis X-X which extends in the plane PMC and which is an axis of symmetry of the connection assembly 100.

The linking element 60 comprises a holding portion 62 which surrounds a circumference of the first connection member of the first polarity 24 and a circumference of the second connection member of the second polarity 28. In the present case, the holding portion 62 is essentially a bar with a rectangular profile.

The linking element 60 is provided with two wings 64, each arranged at one end of the holding portion 62 and having a thickness smaller than the thickness of the holding portion. In the assembled state of the electrochemical element 10, the wings 64 form linking joints with the first wall 42 and the second wall 44.

Each of the first connection member of the first polarity 24 and the second connection member of the second polarity 28 comprises an electrode portion 66 and a terminal portion 68. The terminal portion 68 has a substantially triangular shape. In the present case, the electrode portion 66 comprises the first lateral edge of the trapezoid of the tab of the connection member and the terminal portion 68 comprises the second lateral edge of the trapezoid of the tab of the connection member.

The terminal portion 68 is suitable and intended for being electrically connected to the associated terminal 14 or 16 and the electrode portion 66 is suitable and intended for being electrically connected to the associated electrode 22, 26.

The holding portion 62 defines a boundary between the electrode portion 66 and the terminal portion 68 of each connection member 24, 28.

The linking element 60 is advantageously provided with a spacer portion 70, which extends from the holding portion 62 along a trapezoid base of the tab of the connection member of the first polarity and along a trapezoid base of the tab of the connection member of the second polarity. The spacer portion 70 coats the edge of each tab of the connection member and extends on either side of the median plane PM. The spacer portion 70 has a shorter length than the length of the associated trapezoid base. The spacer portion 70 contributes to electrically isolating the first connection member of the first polarity 24 and the second connection member of the second polarity 28 by maintaining a physical distance.

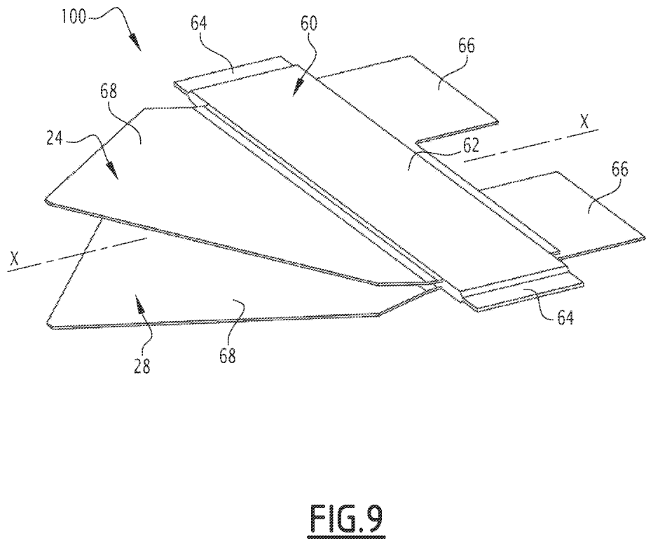

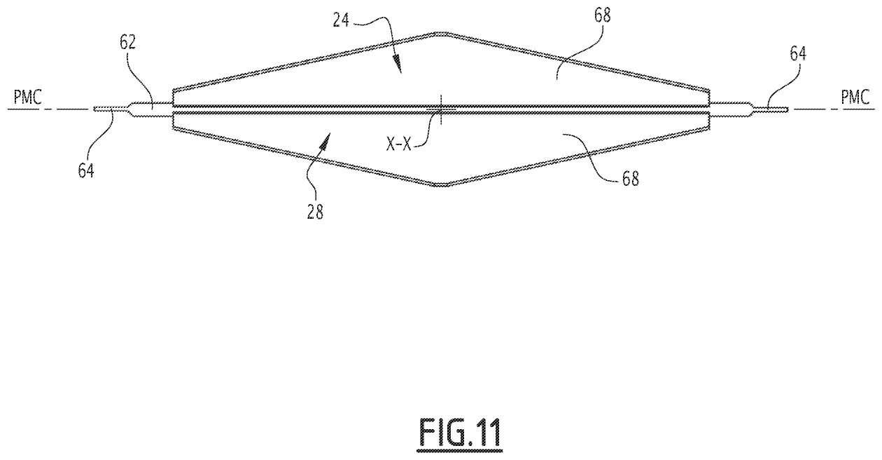

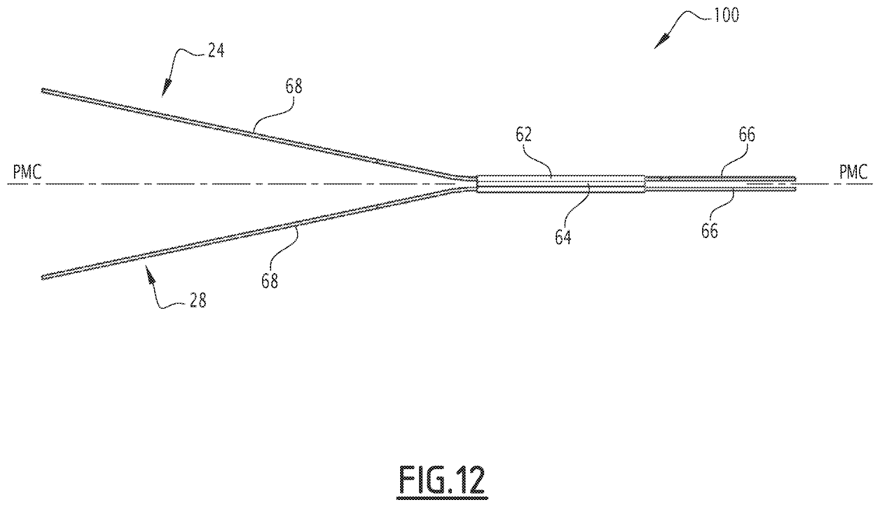

FIGS. 9 to 12 show a connection member 100 according to an embodiment. Such embodiment differs from the first embodiment only in the following. Similar members have the same references.

The first connection member of the first polarity 24 and the second connection member of the second polarity 28 are not arranged side by side along the median plane PM but overlap or are juxtaposed.

Moreover, the first connection member of the first polarity 24 and the second connection member of the second polarity 28 are arranged on both sides of the median plane PM, respectively of the plane PMC.

The terminal portion 68 of each of the first connection member of the first polarity 24 and the second connection member of the second polarity 28 has a substantially isosceles triangle shape. The vertex of the isosceles triangle advantageously coincides with the associated corner C1 or is the point of each connection member closest to the corner C1.

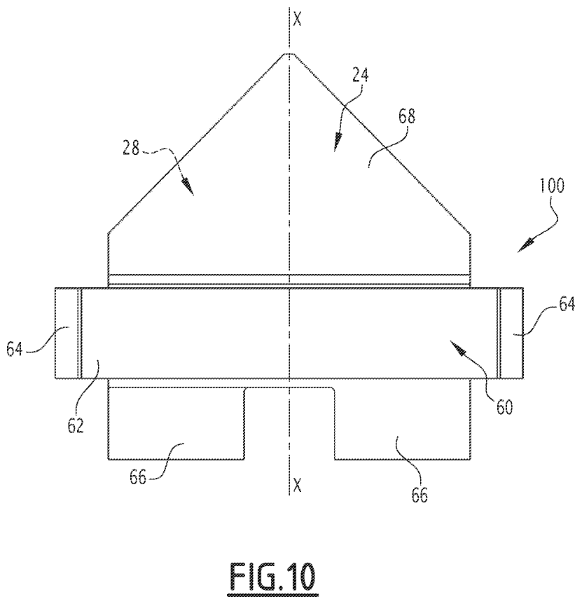

The terminal portion 68 of the first connection member of the first polarity 24 and the terminal portion 68 of the second connection member of the second polarity 28 have identical shapes and, seen perpendicularly to the plane PMC (see FIG. 10), coincide.

The electrode portion 66 of each of the first connection member of the first polarity 24 and the connection member of the second polarity 28 has a substantially rectangular shape and a width, measured perpendicular to the X-X axis and parallel to the plane PMC, less than half the width of the base of the isosceles triangle of the terminal portion 68.

In addition, the electrode portion 66 of the connection member of the first polarity 24 and the electrode portion 66 of the connection member of the second polarity 28 are offset from each other in the plane PMC so as not to overlap (see FIG. 10). Thereby, the connection of each of the electrode portions 66 to the associated electrode is easy.

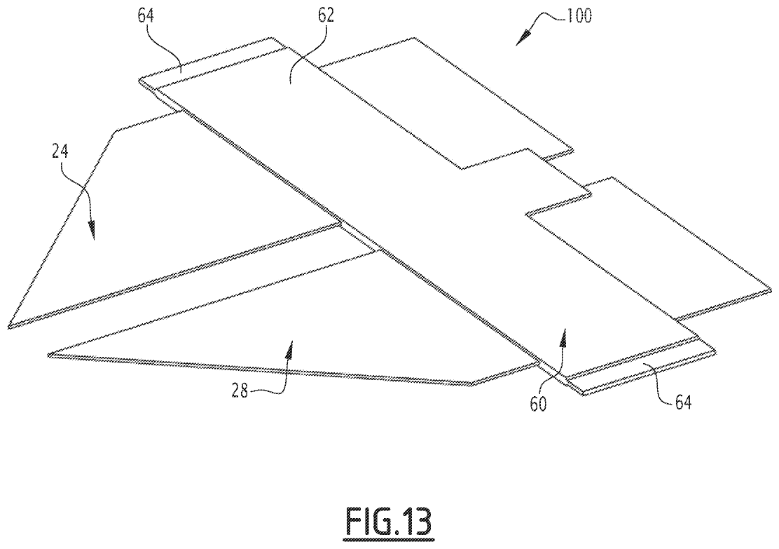

FIG. 13 shows a connection assembly 100 according to a third embodiment. Such embodiment differs from the first embodiment only in the following. Similar members have the same references.

The connecting element 60 does not comprise any spacer portion 70.

The electrical insulation between the first connection member of the first polarity 24 and the second connection member of the second polarity 28 is thus mainly provided by the distance between the two tabs. The advantage of such embodiment is to have more flexible tabs to connect a plurality of pouches, in particular in the case of thick pouch (total thickness greater than 5 mm).

Placing the connection members in the corners of the cell reduces the inactive zone of the electrodes, needed for the connection, and maximizes the electrode zones coated with the mixture of active material. Grouping two connection members in a corner, further increases the active zones of the electrodes. Compared with a conventional design with opposite connection members, a gain of 6.5% in energy can be estimated, for an identical projected surface area.

In addition, placing the connection members in a corner makes it possible to integrate the surface area of the connection members into the total footprint of the cell and hence to facilitate the integration thereof into a module by giving the possibility of not bending the connection members for connecting the cells with each other. With a conventional design, the folding of the connection members for the inter-cell connection is necessary if the bulk of the cell is to be minimized. The above leads to an additional manipulation during the assembly of the module and the weakening of the connection members.

Another advantage lies in the fact that the integration of the two connection members in one location reduces the number of heat-welds and hence the potential leakage zones. The above will thus increase the reliability of the sealing of the cell.

In a variant (not shown), the electrochemical element 10 comprises a third connection member of the first polarity and a fourth connection member of the second polarity, and such connection members are arranged in a corner of the enveloping quadrilateral, different from the first corner C1 and in particular in a corner opposite the first corner C1. For example, the third connection member of the first polarity and the fourth connection member of the second polarity are arranged in the corner C3.

In a further variant (not shown), the electrochemical element 10 instead of comprising a linking element 60 which links the first connection member of the first polarity 24 and the second connection member of the second polarity 28, comprises two separate linking elements 60, each of which surrounds only one of the terminals 24, 28, and which are linked by means of the walls 42, 44.

1. An electrochemical element for a battery, of the type comprising
a first electrode of a first polarity,
a first connection member of the first polarity,
a second electrode of a second polarity,
a second connection member of the second polarity,
a casing comprising a first wall and a second wall,
the envelope comprising at least one first edge and at least one second edge,
the first and second edges forming an enveloping geometric shape having at least one corner,
wherein
the first connection member of the first polarity and the second connection member of the second polarity are arranged completely within the enveloping geometric shape, wherein
the first connection member of the first polarity is arranged in a first corner of the enveloping geometric shape and
wherein the second connection member of the second polarity is also arranged in the first corner of the enveloping geometric shape.

2. The electrochemical element according to claim 1, wherein the enveloping geometric shape is an enveloping quadrilateral.

3. The electrochemical element according to claim 1, wherein exclusively a connection member of the first polarity and a connection member of the second polarity are arranged in only one corner of the enveloping geometric shape and in no other corner of the enveloping geometric shape, which may be present, is a connection member of the electrochemical element arranged.

4. The electrochemical element according to claim 1, wherein
the first connection member of the first polarity and the second connection member of the second polarity are arranged side-by-side or wherein
the first connection member of the first polarity and the second connection member of the second polarity are juxtaposed.

5. The electrochemical element according to claim 1, wherein the first connection member of the first polarity includes a terminal portion or wherein the second connection member of the second polarity includes a terminal portion, wherein each terminal portion is suitable for being electrically connected to an associated terminal and wherein each terminal portion has a substantially triangular shape.

6. The electrochemical element according to claim 1, wherein the electrochemical element comprises a linking element of plastic material which holds together the first connection member of the first polarity and the second connection member of the second polarity in a predetermined configuration and electrically isolates the first connection member of the first polarity from the second connection member of the second polarity.

7. The electrochemical element according to claim 6, wherein the connection member is overmolded around the first connection member of the first polarity and of the second connection member of the second polarity.

8. The electrochemical element according to claim 1, wherein the first connection member of the first polarity or the second connection member of the second polarity is or are attached to the respective electrodes thereof.

9. The electrochemical element according to claim 1, wherein the first wall and the second wall each comprise a metal base sheet and wherein the metal base sheets each have a thickness comprised between 20 μm to 150 μm.

10. A battery, comprising a housing and at least one electrochemical element, the battery preferentially comprising a first terminal and a second terminal wherein, the at least one electrochemical element is an element according to claim 1.

11. The electrochemical element according to claim 2, wherein the enveloping quadrilateral is a rectangle or a trapezoid.

12. The electrochemical element according to claim 8, wherein, the first connection member of the first polarity or the second connection member of the second polarity is or are attached to the respective electrodes thereof by ultrasonic welding.

13. The electrochemical element according to claim 1, wherein the thickness of the metal base sheets is comprised either between 30 μm and 60 μm or between 60 μm and 100 μm or between 60 μm and 90 μm.

14. The battery according to claim 10, wherein the battery is a Lithium-Ion battery.

15. The battery according to claim 10, wherein the first connection member of the first polarity is electrically connected to the first terminal and the second connection member of the second polarity is electrically connected to the second terminal.
